(19) United States
(12) Patent Application Publication
(10) Pub. No.: US 2021/0347238 A1
(43) Pub. Date: Nov. 11, 2021

(54) DOOR WEATHER STRIP AND OPERATING MECHANISM FOR DOOR WEATHER STRIP CORRESPONDING TO DOOR OPEN/CLOSED STATE

(71) Applicant: TOYODA GOSEI CO., LTD., Kiyosu-shi, Aichi-ken (JP)

(72) Inventors: Takeshi Oshima, Kiyosu-shi, Aichi-ken (JP); Tomohiro Dosaki, Kiyosu-shi, Aichi-ken (JP)

(21) Appl. No.: 17/278,104

(22) PCT Filed: Sep. 20, 2019
(86) PCT No.: PCT/JP2019/036902

§ 371 Date: Mar. 19, 2021

(30) Foreign Application Priority Data
Oct. 18, 2018 (JP) 2018-196597

(51) Int. Cl. B60J 10/244; B60J 10/242; B60J 10/86

(52) U.S. Cl. CPC B60J 10/244; B60J 10/86; B60J 10/242

(57) ABSTRACT

Provided is a door weather strip that provides excellent closing performance of a door and sound insulation properties, and does not impair the appearance. A door weather strip includes a mounting base and a hollow seal portion. The mounting base has a hole penetrating the mounting base, and the hole is mounted with a valve penetrating the mounting base. At the time of manufacturing a vehicle, the door is closed with the valve open, so that the air within the hollow seal portion is discharged to compress and shape the hollow seal portion (first step). When the door is opened, the valve is closed to retain the shaped state of the hollow seal portion (second step). The valve is opened again at a time point when the hollow seal portion begins to come into contact between the door and the vehicle body opening while the door is closing, or at a time point when the door is closed (third step).

### TECHNICAL FIELD

The present invention relates to a door weather strip that seals a gap between a door of an automobile and a peripheral edge of a vehicle body opening.

### BACKGROUND ART

As shown in FIG. 9, a door of an automobile is mounted with a door weather strip 100 that seals a gap between the door and a peripheral edge of a vehicle body opening. The door weather strip 100 includes a mounting base 200 that is mounted to a peripheral edge of the door and a hollow seal portion 300 that is pressed against the peripheral edge of the vehicle body opening when the door is closed, and the hollow seal portion 300 is pressed against the peripheral edge of the vehicle body opening and deforms, so that the sealing function is exhibited.

However, there is a problem that, when the hollow seal portion 300 is pressed against the peripheral edge of the vehicle body opening and deforms, the air within the hollow seal portion 300 is not discharged, so that the seal reaction force is increased, resulting in deterioration in the closing performance of the door and therefore the operability of the door.

Thus, for example, Patent Literature 1 proposes that, as shown in FIG. 10, a ventilation hole 310 for discharging the air within the hollow seal portion 300 is provided, in the indoor side part, at a position where it is not blocked by the peripheral edge of the vehicle body opening when the hollow seal portion 300 is pressed against the peripheral edge of the vehicle body opening and deforms, to weaken the seal reaction force and improve the closing performance of the door.

Further, for example, Patent Literature 2 describes a weather strip equipped in a work machine such as a hydraulic excavator, a bulldozer, or a wheel loader, wherein a vent 230 for sucking air into the hollow seal portion 300 or discharging the air within the hollow seal portion 300 when the door is opened or closed is provided in a mounting surface 210, and a hole 250 is provided in an inner panel 240 of the door at a door frame 2 is provided so as to correspond to the vent 230, as shown in FIG. 11. The door weather strip 100 is mounted to the inner panel 240 of the door with a clip 270 having a through hole 260 communicating the vent 230 and the hole 250. Further, Patent Literature 2 proposes that the inside of the hollow seal portion 300 is divided into a first chamber 330 and a second chamber 340 by a partition wall 320, and the partition wall 320 is provided with a communication hole 350 that communicates the first chamber 330 and the second chamber 340, and thus that, when the hollow seal portion 300 is pressed against a peripheral edge of a door mounting opening or a peripheral edge of the door, the air within the hollow seal portion 300 is discharged from the vent 230 provided in the mounting surface 210 of the door weather strip 100 through the hole 250 provided at the peripheral edge of the door or the peripheral edge of the door mounting opening, so that the seal reaction force can be weakened and that the closing performance of the door is improved.

### CITATIONS LIST

### Patent Literature

Patent Literature 1: JP 2002-154335 A
Patent Literature 2: JP 2007-283817 A

### SUMMARY OF INVENTION

### Technical Problems

However, the weather strip of Patent Literature 1 has a problem of bad appearance since the ventilation hole 310 is exposed to the indoor side.

On the other hand, in the weather strip of Patent Literature 2, the hollow seal portion 300 inevitably deforms significantly when the door is opened/closed, and the energy for the hollow seal portion 300 itself to deform cannot be reduced. In general, the weather strip is extruded to form a uniform cross section. So, in order to absorb variations in the distance between the door and the peripheral edge of the vehicle body opening to ensure sealing between the door and the peripheral edge of the vehicle body opening, the weather strip is made large as a whole according to the maximum value of the distance between the door and the peripheral edge of the vehicle body opening when the door is closed. Therefore, there is a limitation in the reduction of the sealing reaction force. Therefore, it is not possible to sufficiently meet the demand for further reducing the seal reaction force when the door is closed, along with the weight reduction of the door.

### Solutions to Problems

In order to solve the above problems, the present invention according to claim 1 relates to a door weather strip that is mounted to a door of a vehicle or a peripheral edge of a vehicle body opening to seal a gap between the door and the peripheral edge of the vehicle body opening, the weather strip including a mounting base and a hollow seal portion, the mounting base being mounted to the door or the peripheral edge of the vehicle body opening, wherein the mounting base has a hole penetrating the mounting base, the hole is mounted with a valve for discharging the air in the hollow seal portion or sucking air into the hollow seal portion, which penetrates the mounting base, the door weather strip involves: a first step in which, after mounting of the manufactured door weather strip to the door or the peripheral edge of the vehicle body opening, the door is closed with the valve open, and the hollow seal portion is compressed between the door and the peripheral edge of the vehicle body opening, and shaped; a second step in which, when the door starts to open, the valve is closed, and, when the door is open, the valve remains closed to substantially retain the shaped state of the hollow seal portion; and a third step in which the valve is opened at a time point when the door starts to close and the hollow seal portion starts to come into contact between the door and the vehicle body opening while the door is closing, or at a time point when the door is closed, and the weather strip shaped by the first step is subjected to alternate repetition of the second step and the third step in association with the opening and closing of the door.

In the present invention according to claim 1, the weather strip includes a mounting base and a hollow seal portion; the mounting base is mounted to the door or the peripheral edge of the vehicle body opening; the mounting base is provided with a hole penetrating the mounting base; the hole is mounted with a valve for discharging the air within the hollow seal portion or sucking air into the hollow seal portion, which penetrates the mounting base. By the first step, the valve is opened during manufacture and assembly of the vehicle. Therefore, when the door is closed, the air within the hollow seal portion is discharged, so that the door weather strip is compressed and shaped. Accordingly, the seal reaction force from the hollow seal portion can be weakened to improve the closing performance of the door.

Then, when the door is opened/closed after that, the shaped state of the hollow seal portion is substantially retained by the valve opening/closing operation (second step and third step) corresponding to the open/closed state of the door. Thus, the door can be closed with the weather strip having a cross-sectional area smaller than that at the time of manufacture, and the seal reaction force from the hollow seal portion is further weakened as compared with that in the first step, so that the closing performance of the door can be significantly improved. In addition, the phrase “the shaped state of the hollow seal portion is substantially retained” means the inclusion of the feature that, when the door is opened, the soft hollow seal portion that has been pressed by the door or the peripheral edge of the vehicle body opening and deformed is released from pressing, so that its cross-sectional shape changes.

In addition, as compared with door weather strips in which a ventilation hole for discharging the air within the hollow seal portion is provided, in the indoor side part, at a position where it is not blocked by the peripheral edge of the vehicle body opening as in a conventional manner, a ventilation hole can be eliminated. Therefore, the appearance is good, and the sound insulation properties are improved.

The present invention according to claim 2 relates to the door weather strip, wherein, when the door is left open over a long time in the second step, a fourth step of opening the valve is provided, and the process is returned to the first step in order to close the door again.

In the second step, the valve is closed. When the door is left open over a long time, air may flow into the hollow seal portion due to leaks, etc., so that the shaped state of the hollow seal portion may collapse, resulting in swelling of the hollow seal portion toward the shape at the time of manufacture. If the third step is performed in this state, the seal reaction force will be large when the door is closed, because the valve is closed. Therefore, the closing of the door will be significantly deteriorated. Therefore, in the present invention according to claim 2, when the door is left opened over a long time, the hollow seal portion returns to the shape at the time of manufacture by opening the valve through the fourth step of opening the valve. In order to close the door again, the process is returned to the first step so that the hollow seal portion can be compressed and shaped while discharging the air within the hollow seal portion. Accordingly, the seal reaction force from the hollow seal portion can be weakened to improve the closing performance of the door.

The present invention according to claim 3 relates to the door weather strip, wherein the valve includes a first valve and a second valve; the first valve has a flow rate of air per hour greater than a flow rate of air per hour of the second valve; the first step is performed with the first valve open and the second valve closed; the second step is performed with the first valve closed; and the third step is performed with the second valve open.

In the present invention according to claim 3, two types of valves having different air flow rates per hour are used. In the first step with a large amount of deformation of the hollow seal portion, the first valve having a high flow rate of air per hour is opened to efficiently discharge air. In the third step with a small amount of deformation of the hollow seal portion, the second valve having has a low flow rate of air per hour is used, so a small amount of air can be taken in and out precisely.

The present invention according to claim 4 relates to the door weather strip, wherein the valve includes a first valve and a second valve; the first valve has a flow rate of air per hour greater than a flow rate of air per hour of the second valve; when the door is left open over a long time in the second step, the fourth step of opening the first valve is provided; and the process is returned to the first step in order to close the door.

In the second step, both the first valve and the second valve are closed. When the door is left open over a long time, air may flow into the hollow seal portion due to leaks, etc., so that the shaped state of the hollow seal portion may collapse, resulting in swelling of the hollow seal portion toward the shape at the time of manufacture. If the third step is performed in this state, the seal reaction force will be large when the door is closed, because both the first valve and the second valve are closed. Therefore, the closing of the door will be significantly deteriorated. Therefore, in the present invention according to claim 4, when the door is left opened over a long time, the hollow seal portion returns to the shape at the time of manufacture by opening the first valve by the fourth step of opening the first valve. In order to close the door again, the process is returned to the first step so that the hollow seal portion can be compressed and shaped while discharging the air within the hollow seal portion from the first valve having a high flow rate of air per hour. Therefore, air can be efficiently discharged from the hollow seal portion, and the seal reaction force from the hollow seal portion can be weakened to improve the closing performance of the door.

The present invention according to claim 5 relates to an operating mechanism for a door weather strip that is mounted to a door of a vehicle or a peripheral edge of a vehicle body opening to seal a gap between the door and the peripheral edge of the vehicle body opening, wherein the weather strip includes a mounting base and a hollow seal portion, the mounting base being mounted to the door or the peripheral edge of the vehicle body opening, the mounting base has a hole penetrating the mounting base, the hole is mounted with a tube for discharging the air within the hollow seal portion or sucking air into the hollow seal portion, which penetrates the mounting base, the door weather strip involves: a first step in which, after mounting of the manufactured door weather strip to the door or the peripheral edge of the vehicle body opening, the door is closed with the air within the hollow seal portion allowed to flow through the tube, and the hollow seal portion is compressed between the door and the peripheral edge of the vehicle body opening, so that the air within the hollow seal portion is discharged through the tube to shape the hollow seal portion; a second step in which, when the door starts to open, flow of the air within the tube is stopped with the door open to substantially retain the shaped state of the hollow seal portion; and a third step in which the air within the hollow seal portion is allowed to flow through the tube at a time point when the door starts to close and the hollow seal portion starts to come into contact between the door and the vehicle body opening while the door is closing, or at a time point when the door is closed, so that air is allowed to be sucked into or discharged from the hollow seal portion, and the weather strip shaped by the first step is subjected to alternate repetition of the second step and the third step in association with the opening and closing of the door.

In the present invention according to claim 5, the weather strip includes a mounting base and a hollow seal portion; the mounting base is mounted to the door or the peripheral edge of the vehicle body opening; the mounting base is provided with a hole penetrating the mounting base; the hole is mounted with a tube for discharging the air within the hollow seal portion or sucking air into the hollow seal portion, which penetrates the mounting base. By the first step, the door is closed with the air within the hollow seal portion allowed to flow through the tube during manufacture and assembly of the vehicle, and the air within the hollow seal portion is discharged, so that the door weather strip is compressed and shaped. Accordingly, the seal reaction force from the hollow seal portion can be weakened to improve the closing performance of the door. The “tube” means a member having a hollow elongated structure and formed of a resin or metal.

Then, when the door is opened/closed after that, the shaped state of the hollow seal portion is substantially retained by controlling the flow of the air within the tube corresponding to the open/closed state of the door (second step and third step). Thus, the door can be closed with the weather strip having a cross-sectional area smaller than that at the time of manufacture, and the seal reaction force from the hollow seal portion is further weakened as compared with that in the first step, so that the closing performance of the door can be significantly improved. In addition, the phrase “the shaped state of the hollow seal portion is substantially retained” means the inclusion of the feature that, when the door is opened, the soft hollow seal portion that has been has been pressed by the door and deformed is released from the pressing force, so that its cross-sectional shape changes, as in the case of claim 1.

The present invention according to claim 6 relates to the operating mechanism for the door weather strip, wherein, when the door is left open over a long time in the second step, a fourth step of allowing the air within the hollow seal portion to flow through the tube and allowing air to be sucked into the hollow seal portion is provided; and the process is returned to the first step in order to close the door again.

In the second step, the flow of the air within the tube is stopped. When the door is left open over a long time, air may flow into the hollow seal portion due to leaks, etc., so that the shaped state of the hollow seal portion may collapse, resulting in swelling of the hollow seal portion toward the shape at the time of manufacture. If the third step is performed in this state, the seal reaction force will be large when the door is closed, because the flow of the air within the tube is stopped. Therefore, the closing of the door will be significantly deteriorated. Therefore, in the present invention according to claim 6, when the door is left opened over a long time, the air is sucked into the hollow seal portion through the tube by the fourth step of allowing the air within the hollow seal portion to flow through the tube, and the hollow seal portion returns to the shape at the time of manufacture. In order to close the door again, the process is returned to the first step so that the hollow seal portion can be compressed and shaped while discharging the air within the hollow seal portion. Accordingly, the seal reaction force from the hollow seal portion can be weakened to improve the closing performance of the door.

The present invention according to claim 7 relates to the operating mechanism for the door weather strip, wherein the discharge of air out of the hollow seal portion or the suction of air into the hollow seal portion due to the flow of the air within the hollow seal portion through the tube is performed by opening or closing a valve unit of a device including the valve unit.

In the present invention according to claim 7, the discharge of air out of the hollow seal portion or the suction of air into the hollow seal portion due to the flow of the air within the hollow seal portion through the tube is performed by opening or closing a valve unit of a device including the valve unit. Thus, the closing performance of the door can be remarkably improved by a simple means as compared with conventional cases.

### Advantageous Effects of Invention

During manufacture and assembly of the vehicle, the air within the hollow seal portion is discharged, so that the door weather strip is compressed and shaped (first step). Then, when the door is opened/closed after that, the shaped state of the hollow seal portion is substantially retained by the valve opening/closing operation corresponding to the door open/closed state (second step and third step). Thus, the door can be closed with the weather strip having a cross-sectional area smaller than that at the time of manufacture, i.e., the seal reaction force from the hollow seal portion can be greatly weakened, so that the closing performance of the door can be significantly improved. In addition, as compared with door weather strips in which a ventilation hole for discharging the air within the hollow seal portion is provided, in the indoor side part, at a position where it is not blocked by the peripheral edge of the vehicle body opening as in a conventional manner, a ventilation hole can be eliminated. Therefore, the appearance is good, and the sound insulation properties are also improved.

Therefore, when the door is left opened over a long time, the hollow seal portion returns to the shape at the time of manufacture by opening the valve through the fourth step of opening the valve. In order to close the door again, the process is returned to the first step so that the hollow seal portion can be compressed and shaped while discharging the air within the hollow seal portion. Accordingly, the seal reaction force from the hollow seal portion can be weakened to improve the closing performance of the door.

Two types of valves having different air flow rates per hour are used. In the first step where the amount of deformation of the hollow seal portion is large, the first valve having a high flow rate of air per hour is opened to efficiently discharge air. In the third step where the amount of deformation of the hollow seal portion is small, the second valve having has a low flow rate of air per hour is used, so a small amount of air can be taken in and out precisely.

### BRIEF DESCRIPTION OF DRAWINGS

FIG. 1 is a schematic side view of an automobile used in embodiments of the present invention.

FIG. 2 is an overall front view of a door weather strip according to a first embodiment of the present invention.

FIG. 3 is a sectional view taken along the line B-B of FIG. 2.

FIG. 4 is a cross-sectional view taken along the line A-A of FIG. 1 at the end of a first step of the door weather strip according to the first embodiment of the present invention.

FIG. 5 is a cross-sectional view taken along the line A-A of FIG. 1 at the end of a second step of the first embodiment of the present invention.

FIG. 6 is a cross-sectional view taken along the line A-A of FIG. 1 at the end of a third step of the first embodiment of the present invention.

FIG. 7 is a cross-sectional view taken along the line A-A of FIG. 1 at the end of a fourth step of the first embodiment of the present invention.

FIG. 8 is a schematic view showing a cross-sectional view taken along the line A-A of a door weather strip according to a second embodiment of the present invention and a relationship with the arrangement of a valve (at the end of the first step).

FIG. 9 is a cross-sectional view of a conventional weather strip.

FIG. 10 is a cross-sectional view of a conventional weather strip (Patent Literature 1).

FIG. 11 is a cross-sectional view of a conventional weather strip (Patent Literature 2).

### DESCRIPTION OF EMBODIMENTS

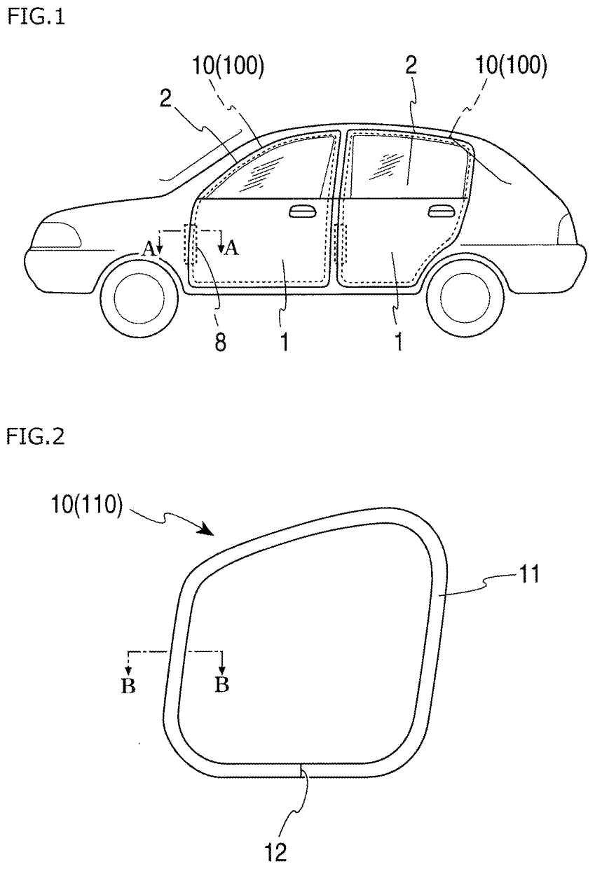

Hereinafter, a door weather strip 10 of a first embodiment of the present invention will be described with reference to FIGS. 1 to 7.

FIG. 1 is a schematic side view of an automobile to which the door weather strip 10 of the present invention is attached. Further, FIG. 2 is an overall front view of the door weather strip 10 according to an embodiment of the present invention.

In the present embodiment, the door weather strip 10 is of a type that is attached to the door, but may be of a type that is attached to a peripheral edge of a vehicle body opening. Moreover, the present embodiment is applicable to all doors. Further, the present embodiment can be applied not only to automobiles but also to work machines such as hydraulic excavators, bulldozers, and wheel loaders.

As shown in FIG. 2, the door weather strip 10 of the present embodiment is connected with an extruded portion 11 formed by extrusion molding at a connection portion 12 and formed in an annular shape. The connection at the connection portion 12 can be any of a splice connection, a mold connection and an adhesive connection.

In the splice connection and the adhesive connection, unlike the mold connection between hollow portions using a general core, it is not necessary to form a slit for pulling out the core, and the airtightness inside the hollow can be improved. This makes it possible to prevent the occurrence of leaks or the like, which will be described later. Moreover, if the core is not used, the mold connection can be adopted without any problem.

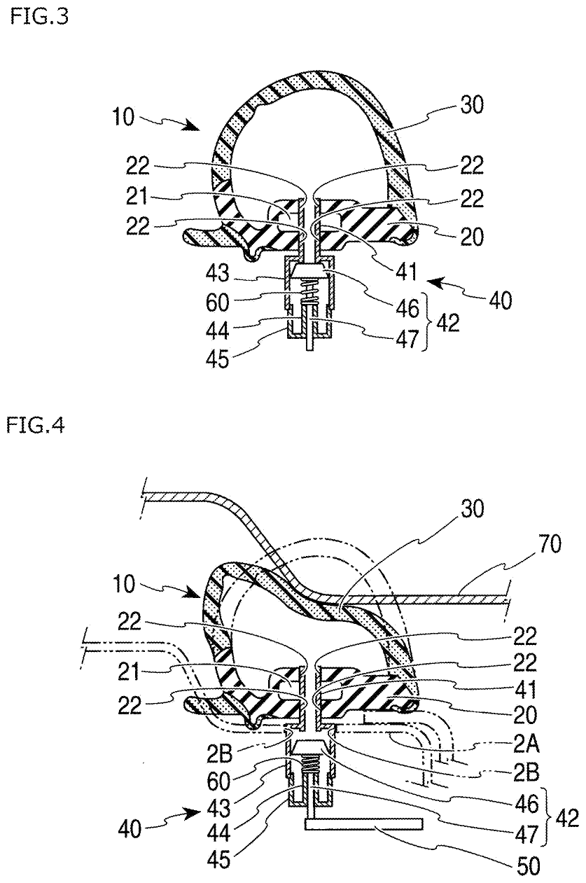

As shown in FIG. 3, the cross-sectional shape of the door weather strip 10 in the extruded portion 11 is formed from a mounting base 20 and a hollow seal portion 30 that is formed integrally with the mounting base 20 and comes into contact with the peripheral edge of the vehicle body opening. The door weather strip 10 at the connection portion 12 has substantially the same shape as a straight portion 11. Further, the mounting base 20 is formed with a mounting base hollow portion 21 for weight reduction.

In the present embodiment, the mounting base 20 of the door weather strip 10 is made of a solid material of EPDM, and the hollow seal portion 30 is made of a sponge material of EPDM. Other rubber members may be used, or a thermoplastic resin may also be used.

A hole 22 penetrating the mounting base 20 is formed in the mounting base 20, and the hole 22 is mounted with a valve 40 for discharging the air within the hollow seal portion 30 or sucking air into the hollow seal portion 30.

The valve 40 includes an insertion portion 41 that is inserted into the hole 22 that penetrates the mounting base 20, a first tubular portion 43 that has a larger outer diameter than that of the insertion portion 41 and has a movable valve unit 42 that opens/closes the valve 40 inside, and a second tubular portion 45 having a valve unit guide unit 44 that guides the movement of the valve unit 42.

The valve unit 42 includes a valve body portion 46 that opens/closes the valve 40, and a rod portion 47 for allowing the valve body portion 46 to move the valve unit guide unit 44 within the second tubular portion 45. Further, the side of the rod portion 47 opposite to the valve body portion 46 is later connected to a switch unit 50 that moves the valve unit 42 and opens/closes the valve 40.

The insertion portion 41 and the first tubular portion 43 of the valve 40 are integrally molded, and the first tubular portion 43 and the second tubular portion 45 are integrated by adhesion after a spring 60 is mounted to the rod portion 47 of the valve unit 42, and the rod portion 47 of the valve unit 42 is inserted into the valve unit guide unit 44 of the second tubular portion 45. In the present embodiment, the valve 40 is closed at an initial stage. The valve 40 was made of a resin, except for the spring 60.

Next, the mounting of the valve 40 to the door weather strip 10 and the attachment of the door weather strip 10 to an inner panel 2A of the door will be described below. First, the insertion portion 41 of the valve 40 coated with an adhesive is inserted into the hole 22 penetrating the mounting base 20 of the door weather strip 10 to integrate the door weather strip 10 and the valve 40.

Next, the end of the rod portion 47 of the valve 40 opposite to the valve body portion 46 and the switch unit 50 are installed in the inner panel 2A of the door in advance. After connection with the end of the switch unit 50 protruding from a hole 2B provided in the inner panel 2A of the door, the valve 40 is inserted through the hole 2B into the inner panel 2A of the door. At the same time, a clip (not shown) mounted to the door weather strip 10 is inserted into a hole (not shown) different from the hole 2B provided in the inner panel 2A of the door. Then, the attachment of the door weather strip 10 to the inner panel 2A of the door is completed. The switch unit 50 is drawn in the vicinity of the valve 40 in FIG. 4 and the subsequent FIGS. 5 to 7, but may be mounted at a position away from the valve 40 as long as the rod portion 47 can be moved.

Next, the relationship between the opening/closing of the valve 40 along with the opening/closing of the door and the deformation of the hollow seal portion 30 of the door weather strip 10, i.e., the first step to the third step, will be described with reference to FIGS. 4 to 6.

First, the switch unit 50 is operated to open the valve 40. Then, the door is closed. As a result, as shown in FIG. 4, the valve 40 is open. Thus, when the door is closed, the hollow seal portion 30 of the door weather strip 10 is compressed and deformed between the inner panel 2A of the door and a vehicle body outer panel 70 at the peripheral edge of the vehicle body opening, and shaped (first step). Therefore, air is discharged from the hollow seal portion 30, and the seal reaction force from the hollow seal portion 30 is reduced, so that the closing performance of the door is improved.

Next, when the operation of opening the door is performed, an upper portion of the valve unit 42 in the valve 40 is raised, due to the spring 60 returning to the original position, by the switch unit 50, in conjunction with the operation. The valve body portion 46 comes into contact with a top of the first tubular portion 43, so that the valve is closed (second step). As a result, as shown in FIG. 5, even when the door is opened so that the hollow seal portion 30 is released from compression between the inner panel 2A of the door and the vehicle body outer panel 70 at the peripheral edge of the vehicle body opening, no air is sucked into the hollow seal portion 30, and the previous shaped state is retained. However, due to the elasticity of the hollow seal portion 30, when it is released from compression, it tries to return to a stable shape even when it is shaped, and its shape changes slightly from the previous shaped state. FIG. 5 is drawn in consideration of this change.

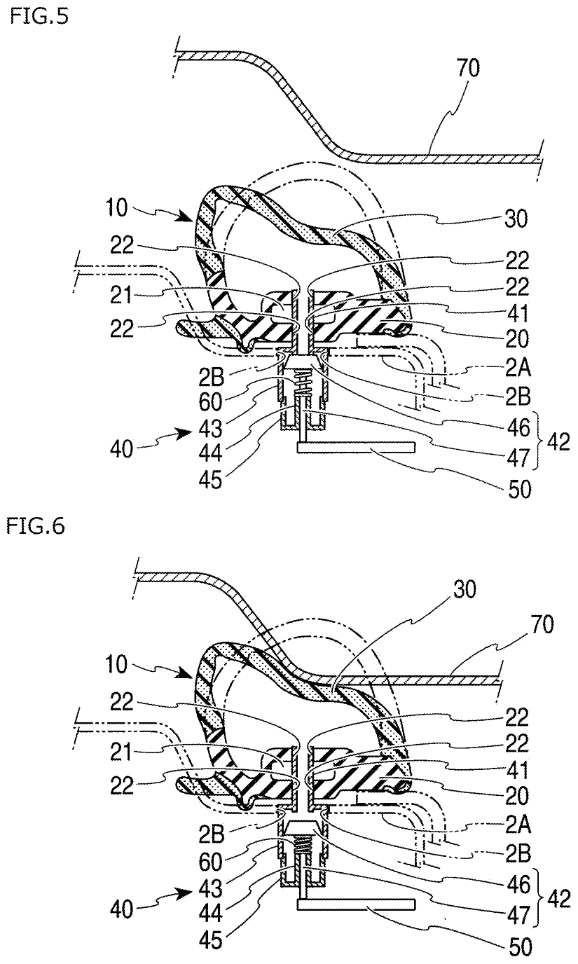

Next, the operation of closing the door is performed again, and, when it is detected that the hollow seal portion 30 has come into contact with the vehicle body outer panel 70 at the peripheral edge of the vehicle body opening while the door is closing, the switch unit 50 causes the valve unit 42 within the valve 40 to be lowered so that the valve 40 is open (third step). As a result, as shown in FIG. 6, the hollow seal portion 30 of the door weather strip 10 is deformed between the inner panel 2A of the door and the vehicle body outer panel 70 at the peripheral edge of the vehicle body opening, and returns to the shape at the end of the first step. After that, the door is opened and closed by repeating the second step and the third step. Therefore, the door can be closed with the weather strip having a smaller cross-sectional area than that at the time of manufacture.

As a result of mockup (model manufactured in almost the same manner as the real automobile at the time of automobile design) evaluation, the energy for closing the door when opening and closing the door by repeating the second and third steps could be reduced by about 25% as compared with the case where a ventilation hole for discharging the air within the hollow seal portion is provided, in the indoor side part, at a position where it is not blocked by the peripheral edge of the vehicle body opening to discharge the air within the hollow seal portion, and the closing performance of the door could be significantly improved. In addition, a ventilation hole was eliminated, so that the sound insulation properties could be improved by about 3 dBA.

In the third step described above, the valve 40 may be opened at a time point when the door is closed. Many vehicles are mounted with a door opening/closing detection switch to notify, for example, the opening/closing of the door to a display unit of an instrument panel. If the switch unit 50 is interlocked with the door opening/closing detection switch, it is not necessary to detect that the hollow seal portion 30 has come into contact with the vehicle body outer panel 70 at the peripheral edge of the vehicle body opening while the door is closing, so that the device is simplified, leading to cost reduction.

When the door is left open over a long time, the valve is closed in the second step. However, when the door is left open over a long time, for example, due to insufficient adhesion between the hole 22 of the mounting base 20 and the insertion portion 41 of the valve 40 or an external force to the door weather strip 10, a portion of the adhesive part between the hole 22 of the mounting base 20 and the insertion portion 41 of the valve 40 may be peeled off, so that air may flow into the hollow seal portion 30 due to leaks or the like, and the shape of the hollow seal portion 30 may collapse, resulting in swelling of the hollow seal portion 30 toward the shape at the time of manufacture. If the third step is performed in this state, the seal reaction force from the swollen hollow seal portion 30 will be large when the door is closed, because the valve is closed. Therefore, the closing of the door will be significantly deteriorated.

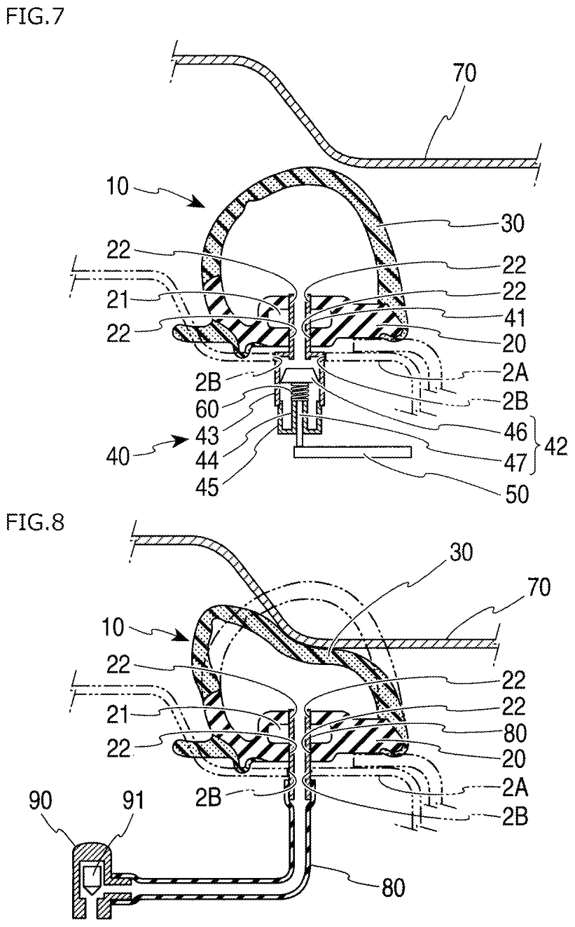

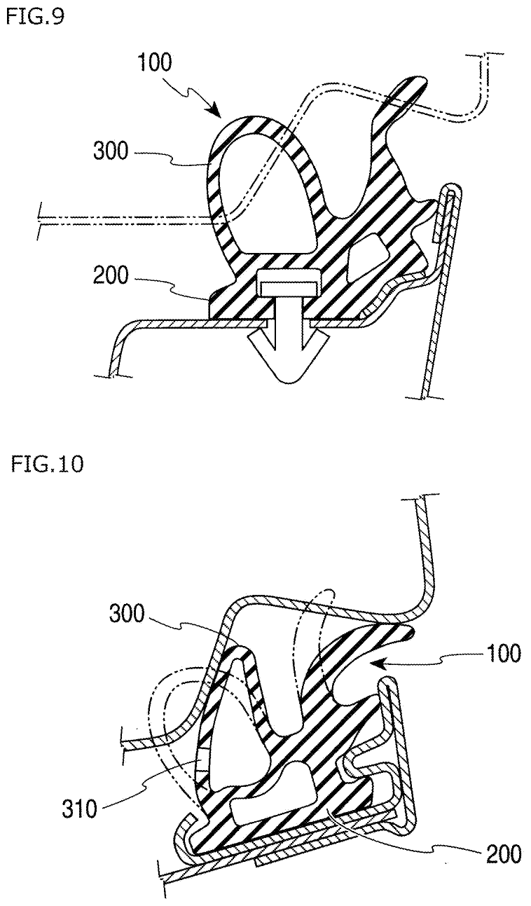

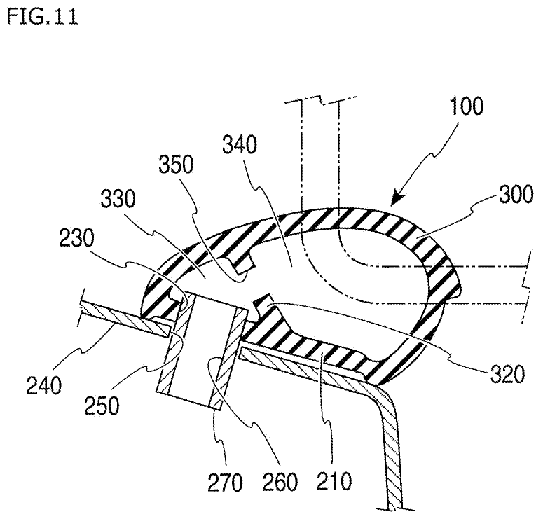

Therefore, in that case, the switch unit 50 is operated to open the valve 40, and the hollow seal portion 30 is returned to the shape at the time of manufacture as shown in FIG. 7 (fourth step). After that, the first step is carried out. As a result, the valve 40 is open. Thus, when the door is closed, the hollow seal portion 30 of the door weather strip 10 is compressed and deformed between the inner panel 2A of the door and a vehicle body outer panel 70 at the peripheral edge of the vehicle body opening, and shaped. Therefore, the seal reaction force from the hollow seal portion 30 can be weakened to improve the closing performance of the door. The “long time” may be determined in consideration of the degree of occurrence of leaks or the like based on the experimental results, such as the materials of the door weather strip 10 and the insertion portion 41 of the valve 40, and the type of the adhesive used. Further, if no leak or the like occurs and the change in cross-sectional area of the hollow seal portion 30 is extremely small, the fourth step may be omitted.

Next, a second embodiment of the present invention will be described with reference to FIG. 8. The differences between the second embodiment and the first embodiment described above reside in that, in the second embodiment, the member inserted into the hole 22 provided in the mounting base 20 of the door weather strip 10 is not the valve 40, but a tube 80, and that the device for discharging the air within the hollow seal portion 30 or sucking air into the hollow seal portion 30 through the tube 80 is installed at a location away from the door weather strip 10.

Further, in the second embodiment, a solenoid valve 90 was used as a device having a valve unit for discharging the air within the hollow seal portion 30 or sucking air into the hollow seal portion 30 through the tube 80. The tube 80 inserted and fixed into the hole 22 provided in the mounting base 20 of the door weather strip 10 and the solenoid valve 90 are connected by the tube 80. Further, the end of the tube 80 connected to the solenoid valve 90 opposite to the solenoid valve 90 is installed at the position of the hole 2B provided in the inner panel 2A of the door in advance.

A tip of the tube 80 of the door weather strip 10 into which the tube 80 is inserted and fixed by adhesion is connected to a tip of the tube 80 which is connected to the solenoid valve 90 and installed at the position of the hole 2B provided in the inner panel 2A of the door to operate the solenoid valve 90, so that the air within the hollow seal portion 30 can flow. The timing of operation of the valve unit 91 of the solenoid valve 90 is the same as in the first embodiment. The effects of the second embodiment are the same as in the first embodiment described above.

Next, a third embodiment of the present invention will be described below. The difference between the third embodiment and the first embodiment resides in that, in the third embodiment, the valve 40 includes two types of valves (a first valve and a second valve) which are different in amount of air passing through the valve. Here, the amount of air passing through the valve, that is, the flow rate of air per hour has a relationship of first valve>second valve. The first valve and the second valve are mounted in holes penetrating the mounting base 20 of the door weather strip 10, each of which is formed so that each valve can be inserted. Table 1 below summarizes the open/closed state of the door in each step and the open/closed states of the valve units of the first and second valves.

TABLE 1
Open/closed state of door (steps) and opening/closing
of first and second valves

| | Open/closed | | |
|---|---|---|---|
| Step | state of door | First valve | Second valve |
| First step | Open → closed | Open | Closed |
| Second step | Closed → open | Closed | Closed |
| Third step | Open → closed | Closed | Open |
| Fourth step | Open | Open | Closed |

Thus, in the first step where the amount of deformation of the hollow seal portion 30 is large, the first valve having a high flow rate of air per hour is opened to efficiently discharge air. In the third step where the amount of deformation of the hollow seal portion 30 is small, the second valve having has a low flow rate of air per hour is used, so a small amount of air can be taken in and out precisely. The effects of the third embodiment are the same as in the first embodiment described above.

When the present invention is carried out, it is not limited to the above embodiments, and various modifications can be made without departing from the object of the present invention.

For example, in the first embodiment, after mounting of the valve 40 to the door weather strip 10, the valve 40 is inserted into the hole 2B provided in the inner panel 2A of the door. However, after mounting of the valve 40 in the hole 2B provided in the inner panel 2A of the door, the insertion portion 41 of the valve 40 may be fixed, for example, by being inserted into or adhered to the hole 22 penetrating the mounting base 20 of the door weather strip 10.

For example, in the first embodiment, the switch unit 50 is used as the valve 40 to mechanically open and close the valve unit 42, but the solenoid valve 90 used in the second embodiment may be used therefor. Further, the valve 40 and the switch unit 50 in the first embodiment may be used in the second embodiment.

For example, in the third embodiment, the first valve and the second valve are mounted in the holes penetrating the mounting base 20 of the door weather strip 10, each of which is formed so that each valve can be inserted. However, two holes 22, as used in the second embodiment, may be provided penetrating the mounting base 20 of the door weather strip 10 so that tubes are inserted into and adhered to the respective holes, and the first valve and the second valve may be installed at separate locations.

### REFERENCE SIGNS LIST

10, 100 Door weather strip
20 Mounting base
22 Hole
30 Hollow seal portion
40 Valve
41 Insertion portion
42 Valve unit
43 First tubular portion
45 Second tubular portion
50 Switch unit
60 Spring
2A, 240 Inner panel
2B, 250 Hole
70 Vehicle body outer panel
80 Tube
90 Solenoid valve
91 Valve unit

1. A door weather strip that is mounted to a door of a vehicle or a peripheral edge of a vehicle body opening to seal a gap between the door and the peripheral edge of the vehicle body opening,
the weather strip comprising a mounting base and a hollow seal portion, the mounting base being mounted to the door or the peripheral edge of the vehicle body opening, wherein
the mounting base has a hole penetrating the mounting base,
the hole is mounted with a valve for discharging the air within the hollow seal portion or sucking air into the hollow seal portion, which penetrates the mounting base,
the door weather strip involves:
a first step in which, after mounting of the manufactured door weather strip to the door or the peripheral edge of the vehicle body opening, the door is closed with the valve open, and the hollow seal portion is compressed between the door and the peripheral edge of the vehicle body opening, and shaped;
a second step in which, when the door starts to open, the valve is closed, and, when the door is open, the valve remains closed to substantially retain the shaped state of the hollow seal portion; and
a third step in which the valve is opened at a time point when the door starts to close and the hollow seal portion starts to come into contact between the door and the vehicle body opening while the door is closing, or at a time point when the door is closed, and
the weather strip shaped by the first step is subjected to alternate repetition of the second step and the third step in association with the opening and closing of the door.

2. The door weather strip according to claim 1, wherein, when the door is left open over a long time in the second step, a fourth step of opening the valve is provided, and the process is returned to the first step in order to close the door again.

3. The door weather strip according to claim 1, wherein the valve includes a first valve and a second valve; the first valve has a flow rate of air per hour greater than a flow rate of air per hour of the second valve; the first step is performed with the first valve open and the second valve closed; the second step is performed with the first valve closed; and the third step is performed with the second valve open.

4. The door weather strip according to claim 3, wherein the valve includes a first valve and a second valve; the first valve has a flow rate of air per hour greater than a flow rate of air per hour of the second valve; when the door is left open over a long time in the second step, the fourth step of opening the first valve is provided; and the process is returned to the first step in order to close the door.

5. An operating mechanism for a door weather strip that is mounted to a door of a vehicle or a peripheral edge of a vehicle body opening to seal a gap between the door and the peripheral edge of the vehicle body opening, wherein
the weather strip includes a mounting base and a hollow seal portion, the mounting base being mounted to the door or the peripheral edge of the vehicle body opening,
the mounting base has a hole penetrating the mounting base,
the hole is mounted with a tube for discharging the air within the hollow seal portion or sucking air into the hollow seal portion, which penetrates the mounting base,
the door weather strip involves:
a first step in which, after mounting of the manufactured door weather strip to the door or the peripheral edge of the vehicle body opening, the door is closed with the air within the hollow seal portion allowed to flow through the tube, and the hollow seal portion is compressed between the door and the peripheral edge of the vehicle body opening, so that the air within the hollow seal portion is discharged through the tube to shape the hollow seal portion;
a second step in which, when the door starts to open, flow of the air within the tube is stopped with the door open to substantially retain the shaped state of the hollow seal portion; and
a third step in which the air within the hollow seal portion is allowed to flow through the tube at a time point when the door starts to close and the hollow seal portion starts to come into contact between the door and the vehicle body opening while the door is closing, or at a time point when the door is closed, so that air is allowed to be sucked into or discharged from the hollow seal portion, and
the weather strip shaped by the first step is subjected to alternate repetition of the second step and the third step in association with the opening and closing of the door.

6. The operating mechanism for the door weather strip according to claim 5, wherein, when the door is left open over a long time in the second step, a fourth step of allowing the air within the hollow seal portion to flow through the tube and allowing air to be sucked into the hollow seal portion is provided; and the process is returned to the first step in order to close the door again.

7. The operating mechanism for the door weather strip according to claim 5, wherein the discharge of air out of the hollow seal portion or the suction of air into the hollow seal portion due to the flow of the air within the hollow seal portion through the tube is performed by opening or closing a valve unit of a device including the valve unit.
